(19) United States
(12) Patent Application Publication
(10) Pub. No.: US 2016/0171567 A1
(43) Pub. Date: Jun. 16, 2016

(54) UNIVERSAL FEEDBACK SYSTEM WITH SITE-LOCAL DATA ACQUISITION AND PRESENTATION

(71) Applicants: Alain J. Cohen, McLean, VA (US); Marc A. Cohen, McLean, VA (US)

(72) Inventors: Alain J. Cohen, McLean, VA (US); Marc A. Cohen, McLean, VA (US)

(73) Assignee: bublup technologies, inc., McLean, VA (US)

(21) Appl. No.: 14/969,825

(22) Filed: Dec. 15, 2015

Related U.S. Application Data
(60) Provisional application No. 62/092,329, filed on Dec. 16, 2014.

(51) Int. Cl. G06Q 30/02; G06F 17/30; G07C 13/00; G06F 3/0484

(52) U.S. Cl. CPC G06Q 30/0282; G06F 3/0484; G06F 17/3053; G07C 13/00

(57) ABSTRACT

Computer-implemented systems and methods for facilitating user entry and review of text-based rating descriptions about products, services, and business practices associated with Internet web pages. Embodiments of the invention comprise a rating module that interfaces with a web browser to receive feedback from a user regarding a web page that is currently being displayed by the web browser. The rating module may store the user feedback on a server. When another user visits the web page at a later time, the rating module can retrieve and display information that incorporates the feedback. In other embodiments, the feedback may be in the form of a rating. A rating may be a textual declaration from a user pertaining to anything associated with a web page. For example, a user may input a declaration concerning an aspect of a web page itself, or an item, entity, or service associated with the web page. When the rating is later presented to another user, the rating module may receive additional feedback from the other user concerning the rating. The additional feedback can affect how the rating should be displayed to subsequent users who visit the web page.

### CROSS-REFERENCE TO RELATED APPLICATIONS

This application claims priority under 35 U.S.C. §119(e) to U.S. Provisional Patent Application No. 62/092,329, entitled “Universal Feedback System with Site-Local Data Acquisition and Presentation,” filed Dec. 16, 2014.

### FIELD OF THE INVENTION

Embodiments of the present invention relate to systems and methods for providing ratings about Internet web pages. More particularly, embodiments of the present invention relate to systems and methods for facilitating user entry and review of text-based rating descriptions about products, services, and business practices associated with Internet web pages.

### BACKGROUND

Mechanisms for providing feedback on the Web through comments or rating systems have become ubiquitous with the growth of online commerce. Many buyers wish to register their satisfaction or dissatisfaction with particular sellers as well as the items or services that were purchased. Prospective buyers may then use this feedback while deciding to purchase a particular item or service from a particular seller.

Most conventional feedback systems utilize some combination of features that permit users to rate something (often on a 4 or 5 point scale) and/or type comments in paragraph form. For example, buyers and sellers on an auction website can rate each other based on their satisfaction with a particular transaction. They provide feedback by indicating whether the user's experience with the transaction was positive or negative and by typing a short summary of their experience. In a similar example, buyers on a massive retailer website can rate the products they have purchased on a five-star scale and provide detailed feedback in paragraph form.

In both of the examples above, rating values are averaged to produce an overall rating score for each buyer, seller, or product. The average rating score, however, is determined without regard to any particular aspect of the person, item, or service being evaluated. That is, the rating is just a number with no explanation. For example, three buyers of a particular camera might rate it poorly because one buyer didn't like the color, another buyer thought the battery life was short, and a third buyer thought it was too heavy. Meanwhile, two other buyers might rate the camera positively because one buyer thought it was well priced and the other thought it took great pictures. An average rating of 2 out of 5 stars in this situation would provide little information to a prospective buyer who is interested in the camera's picture-taking ability.

The prospective buyer must then look to the corresponding comments for more helpful information, but such comments are generally not aggregated in any meaningful way. There may be hundreds or thousands of often lengthy and unorganized comments, and the prospective buyer may quickly become frustrated by comments that have little relevance to his or her particular concerns.

In another example, an independent website may permit users to rate and review restaurants, shops, and other businesses. Much like the examples above, users of this kind of website may rate businesses on a five-star scale and type lengthy reviews about their experiences with those businesses. As with the other examples, prospective buyers can obtain a general idea of how positively a business is viewed by other buyers, but can quickly become bogged down by the volume of reviews, many of which contain unhelpful information.

Further, when ratings and reviews are separated from the website of the business being reviewed, deciding whether to patronize a particular business becomes a multi-step process. A prospective buyer who is already viewing the website of a particular business must navigate to another site, search for the business of interest, and then read the ratings and reviews. In some cases, the prospective buyer may not even find any ratings or reviews because the independent website lacks any entries for that particular business.

### SUMMARY OF THE INVENTION

Embodiments of the present invention include systems and methods for universally receiving and presenting ratings and reviews for a web page. In an embodiment, a rating module may interface with a web browser to receive feedback from a user regarding a web page that is currently being displayed by the web browser. The rating module can store the feedback on a server. When another user visits the web page at a later time, the rating module can retrieve and display information that incorporates the feedback.

In an embodiment, the feedback may be in the form of a rating. A rating may be a textual declaration from a user pertaining to anything associated with a web page. For example, a user may input a declaration concerning an aspect of a web page itself, or an item, entity, or service associated with the web page. When the rating is later presented to another user, the rating module may receive additional feedback from the other user concerning the rating. The additional feedback can affect how the rating should be displayed to subsequent users who visit the web page.

The above summaries of embodiments of the present invention have been provided to introduce certain concepts that are further described below in the Detailed Description. The summarized embodiments are not necessarily representative of the claimed subject matter, nor do they limit or span the scope of features described in more detail below. They simply serve as an introduction to the subject matter of the various inventions.

### BRIEF DESCRIPTION OF THE DRAWINGS

So the manner in which the above recited summary features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary embodiment of a web page rating system in accordance with the present invention.

FIG. 2 illustrates an exemplary method for rating web pages, from the perspective of a client, in accordance with an embodiment of the invention.

FIG. 3 illustrates an exemplary method for rating web pages, from the perspective of a feedback server, in accordance with an embodiment of the invention.

FIG. 4A illustrates an embodiment of a web browser window with a rating module toolbar in accordance with the present invention.

FIG. 4B illustrates an embodiment of a web browser window with a rating module toolbar in accordance with the present invention, in which the rating module toolbar is enlarged to a maximized state after a user has selected a “rate” button.

FIG. 4C illustrates an embodiment of a web browser window with a rating module toolbar in accordance with the present invention, in which the rating module toolbar is in a maximized state after a user has selected a “view” button.

FIG. 5 is a block diagram of an exemplary embodiment of a computing device, in accordance with the present invention.

### DESCRIPTION OF THE EMBODIMENTS

Embodiments of the present invention will be described with reference to the accompanying drawings, wherein like parts are designated by like reference numerals throughout, and wherein the leftmost digit of each reference number refers to the drawing number of the figure in which the referenced part first appears.

As noted above, users of conventional web page feedback systems often struggle to find feedback that is relevant to their particular interests. Useful information may be buried among hundreds or thousands of comments. While some conventional systems highlight comments that other users have found to be helpful, the comments may still be long and generally disorganized. Further, some web pages may have no feedback system at all, thereby forcing users to look to other websites or to go entirely without information regarding other users' experiences with those web pages. The embodiments described herein address these and other problems with the prior art.

For purposes of this description, the term “user” refers to a human who uses a web browser or similar software application to navigate the World Wide Web. A user may be a past buyer of a product or service, a prospective buyer, or any other individual interested in leaving or reviewing feedback associated with some aspect of a web page. In some embodiments, a user may also include an automated tool (e.g., a bot or spider) that simulates the actions of users.

In an embodiment, a rating module installed within a web browser permits users to leave and review feedback associated with the web page that they are currently viewing. The rating module includes a graphical user interface, for example a toolbar, with which users can interact. When a user leaves feedback for a particular web page, the rating module stores the feedback in a data repository that is accessible to other users, for example in a server connected to a network. Then, when users visit the web page, the rating module automatically retrieves the previously stored feedback associated with that web page. In this manner, users can seamlessly leave and review feedback concerning any aspect of any web page. In other words, feedback is not limited to particular pages, and users do not have to visit entirely separate web pages to view feedback for a web page of interest. The feedback is available from the rating module at the same time the user is accessing and viewing a web page.

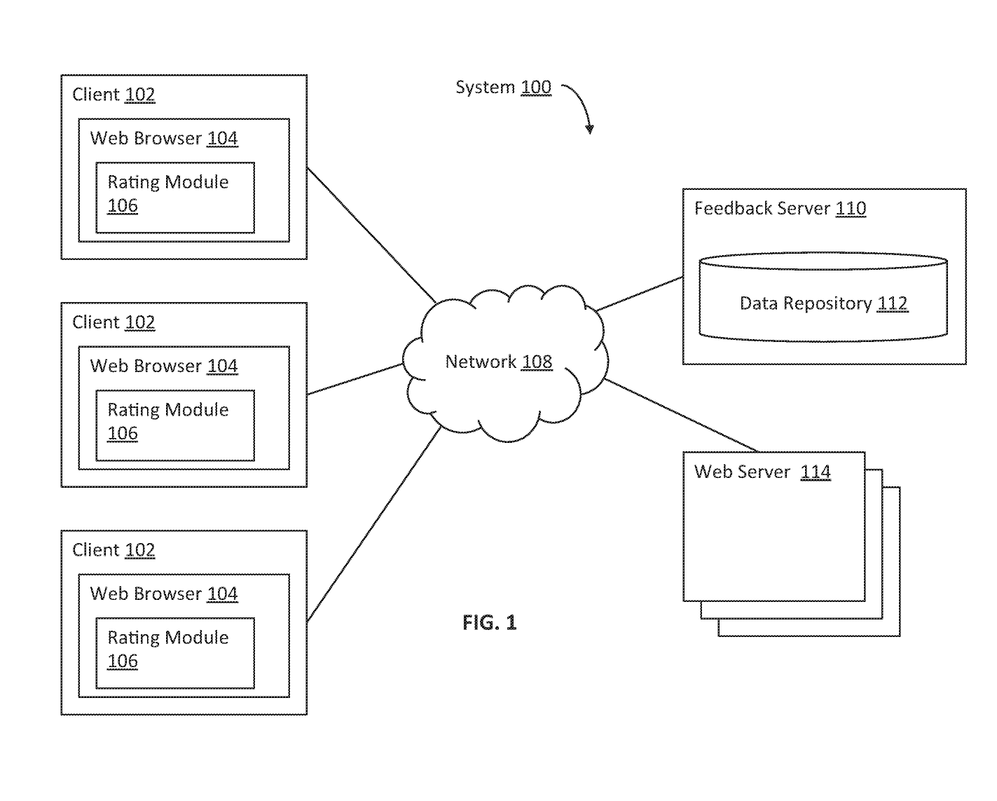

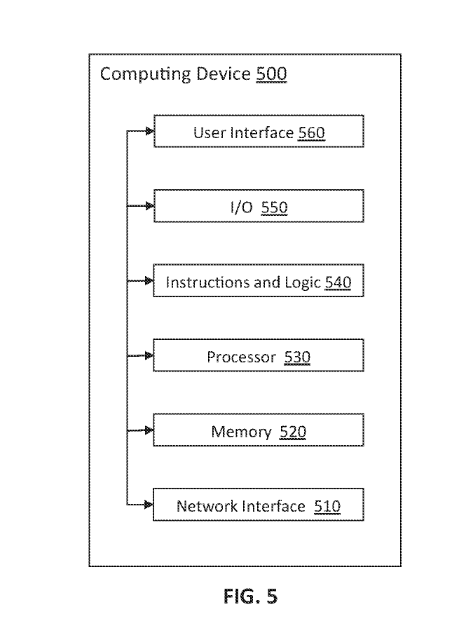

Referring now to FIG. 1, in an embodiment, a system 100 includes one or more clients 102 with which users may access web pages provided by a Web Server 114. A Client 102 may be any type of computing device 500 (see FIG. 5), including, for example, a desktop computer, laptop computer, or mobile device. Each Client 102 includes a Web Browser 104 and a Rating Module 106. Web Browser 104 can be any web browser, including any well-known conventional web browser, which is capable of interfacing with Rating Module 106. In an embodiment, Rating Module 106 is a software module (e.g., written in JavaScript or another programming language supported by Web Browser 104) that interfaces with Web Browser 104. Using application programming interfaces (APIs) according to well-known techniques, Rating Module 106 may run within the Web Browser 104 or it may run externally and interface with the web browser. Rating Module 106 may also be a permanent component of Web Browser 104, or it may be installed into and uninstalled from Web Browser 104 (e.g., as a “plug-in,” “add-on,” or “extension”). Accordingly, Rating Module 106 may be a software module that is separate and distinct from Web Browser 104, or it may be partially or fully integrated with other functionality of Web Browser 104. In an embodiment, Rating Module 106 may load other software (e.g., software from Feedback Server 110) into Web Browser 104 at runtime. For purposes of this description, such other software shall also be considered a part of Rating Module 106.

In embodiments, Web Browser 104 invokes Rating Module 106 each time Web Browser 104 loads or displays any web page. In this manner, the features of Rating Module 106 are available to users for any and all web pages they visit.

Each Client 102 can connect to a Web Server 114 and a Feedback Server 110 across a Network 108 (e.g., the Internet). Web Server 114 is well known in the art and may be any computer, including computing device 500 (see FIG. 5), that is capable of hosting web pages and serving them to requesting clients. Feedback Server 110 is a computer, such as computing device 500, that is capable of running a software application, storing web page feedback in a Data Repository 112, and communicating with the one or more clients 102 across the Network 108. In an embodiment, Data Repository 112 is a database (e.g., a relational database or NoSQL database). In an embodiment, system 100 may include more than one Feedback Server 110, and the Data Repository 112 may reside within Feedback Server 110 or within another computer (not pictured).

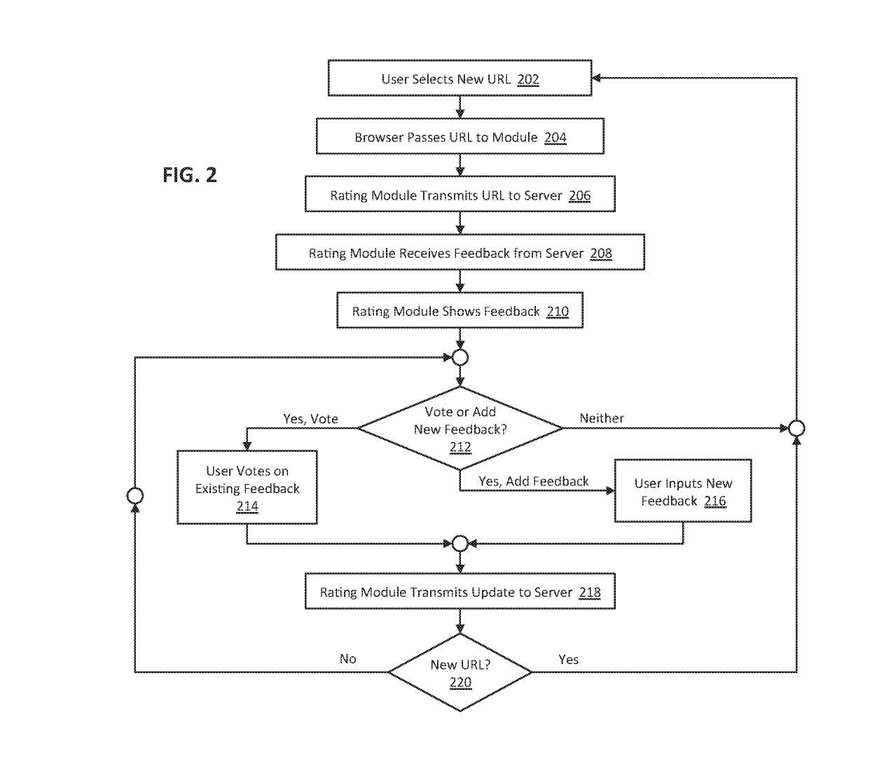

FIG. 2 illustrates an exemplary method for rating web pages, from the perspective of a client, in accordance with an embodiment of the invention. At step 202, a user at a client device (e.g., Client 102) uses a web browser (e.g., Web Browser 104) to request a web page of interest from a web server (e.g., Web Server 114). The web page has an address or uniform resource locator (“URL”) (for purposes of this specification, “address” and “URL” are used interchangeably) that identifies the location of the web page. At step 204, the web browser passes the URL to a rating module (e.g., Rating Module 106). For purposes of this description, step 204 broadly encompasses any mechanism by which the rating module acquires the URL. For example, the browser may send a notification to the rating module or the rating module may request the URL via a browser API. At step 206, the rating module transmits the URL to a feedback server (e.g., Feedback Server 110). At step 208, the rating module receives feedback from the server corresponding to the web page requested by the user. In an embodiment, the feedback is in the form of one or more user ratings associated with the web page as discussed in greater detail below.

At step 210, the rating module shows the feedback (if any exists) to the user. At step 212, the user decides whether he or she wants to vote on the existing feedback at step 214 or input new feedback at step 216. The user indicates his or her decision by interacting with the rating module, for example by selecting one or more corresponding buttons on a toolbar as described in further detail below. A user may also simply decide to review the feedback that is shown without voting or adding new feedback, in which case the method loops back to step 202.

At step 214, the user votes by interacting with the rating module, for example by selecting a corresponding button on a toolbar as discussed in greater detail below. At step 216, the user enters new feedback, again by interacting with the rating module. The user may, for example, type text into a text box and select one or more buttons on a toolbar to submit the feedback.

Whether the user enters new feedback or votes on existing feedback, the rating module transmits the respective information to the feedback server at step 218. At step 220, the method loops back to step 202 if the user navigates to a new web page or step 212 if the user stays on the same web page.

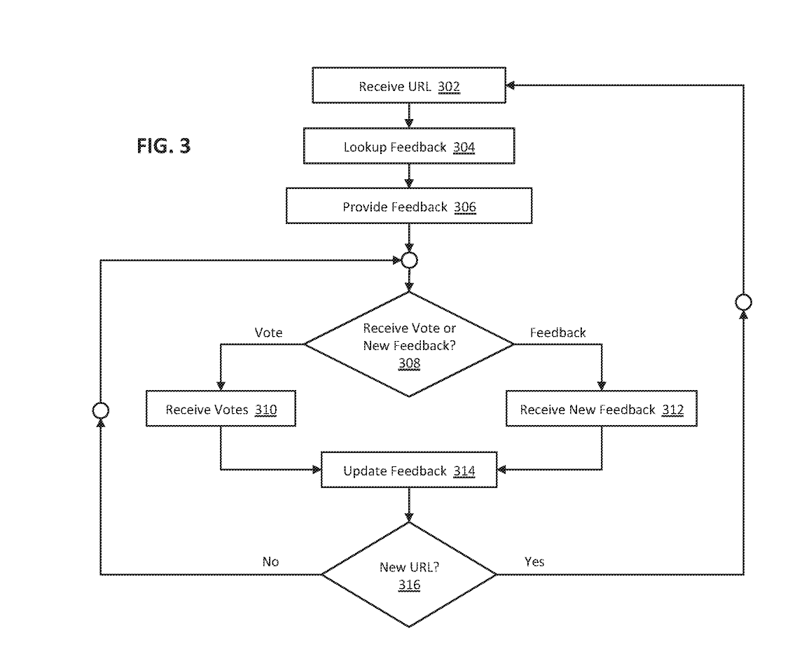

FIG. 3 illustrates an exemplary method for rating web pages, from the perspective of a feedback server, in accordance with an embodiment of the invention. At step 302, a feedback server (e.g., Feedback Server 110) receives a URL from a client (e.g., Client 102), or more particularly, from a rating module (e.g., Rating Module 106) installed on the client. The URL corresponds to the location of a web page requested by the client. At step 304, the feedback server uses the URL to locate feedback for the corresponding web page within a data repository (e.g., Data Repository 112). At step 306, the feedback server transmits at least a portion of the feedback to the rating module for presentation to the user.

Feedback may be stored within the data repository according to well-known techniques. For example, feedback may be stored in a table indexed by URL. In an embodiment, a hashing function is applied to URLs, and the feedback is indexed according to the result of the hashing function.

At steps 308, 310, and 312, the feedback server receives new feedback or votes concerning existing feedback. At step 314, the feedback server updates the feedback stored in the data repository with the newly received information. At step 316, the method loops back to step 302 if the user requests a new web page or step 308 if the user remains on the current web page.

In embodiments, two or more URLs may be associated with the same web page or content. This can happen when a web page is moved to a new location or if there are multiple current URLs pointing to the same web page or content. For example, a web server may “redirect” a request comprising a shorthand or alternative URL for a web page to a different URL for the web page. Additionally, a single web page may comprise multiple versions that are each dependent on, for example, whether a user views the content from a desktop or mobile device. In such cases, a web server may redirect a request for a desktop version (accessible via a first URL) to a mobile version (accessible via second URL), and vice versa.

In such embodiments, the feedback server consolidates URLs that are associated with the same web page or content. Accordingly, users may add and review feedback for that web page regardless of which URL they visited. In one such embodiment, the feedback server determines that two URLs correspond to the same web page by intercepting browser communications. For example, a plug-in, extension, or other software component (such as Rating Module 106) may interface with a browser to intercept communications between the browser and a web server. Such communications generally include both the originally requested URL and the redirected URL. The intercepting software may then transmit both URLs to the feedback server.

In the same or an alternative embodiment, the feedback server may analyze a web page associated with a URL to identify a canonical tag. A canonical tag is a means by which web page authors may notify search engines and other tools that a primary URL identifies a web page, regardless of how many different URLs are associated with the same web page or content. For example, an author may insert the HTML tag, <link href=“http://www.example.com/”rel=“canonical”/> to indicate that the current URL and www.example.com (the “canonical URL”) are associated with the same web page or content.

In embodiments, the feedback server can scan web pages for canonical tags dynamically (e.g., when the feedback server receives a URL from a client) or at some predefined time. In the same or alternative embodiments, a plug-in, extension, or other software component (such as Rating Module 106) may interface with the browser to scan web pages for canonical tags and transmit canonical URLs to the feedback server in addition to, or instead of, the actual URLs. By identifying and interpreting canonical tags in web pages, the feedback server can determine that two or more URLs are associated with the same web page or content, and consolidate the URLs and all existing or subsequently added feedback associated with those URLs.

In the same or an alternative embodiment, the feedback server may search through all URLs in the data repository, looking for URLs with similar elements. For example, the difference between two URLs corresponding to a desktop version of a web page (for example, www.yahoo.com) and a mobile version of the same page (for example, m.yahoo.com) is often very insubstantial and easily identifiable by a pattern-matching algorithm. The feedback server may perform such a search on a periodic basis or on demand when a adds or requests feedback for a particular web page. Once the feedback server receives and/or identifies two or more URLs associated with the same web page, it consolidates the URLs and all existing or subsequently added feedback associated with those URLs.

In an embodiment, feedback is in the form of one or more ratings. A rating includes a declaration describing some aspect of the current web page or a corresponding item, entity, or service. For example, the current web page may belong to a car manufacturer, and the declaration may describe an aspect of: the web page (e.g., “The web page is difficult to use.”), the car (e.g., “The car is very reliable.”), the manufacturer (e.g., “X Motors has a long history of innovation.”), or a service (e.g., “The warranty service was disappointing.”).

A rating may include a positive or negative indicator submitted by a user. The indicator can enable a software application (e.g., a software application on Feedback Server 110) to classify a rating as positive or negative. In the same or an alternative embodiment, the feedback server may perform a linguistic analysis of the rating text to automatically determine whether the rating is positive or negative. The feedback server may use such positive/negative classifications (whether user-supplied or automatically determined) to organize ratings by type when they are presented to users and/or to aggregate the ratings and derive trends or other information about the aspect being rated.

In an embodiment, users may express their agreement or disagreement with a rating by voting. Voting may be binary (e.g., yes or no) or based on a scale representing various levels of agreement or disagreement. For example, on a four-point scale, 1 may represent strong disagreement, 2 may represent mild disagreement, 3 may represent mild agreement, and 4 may represent strong agreement.

Voting information is useful in a variety of ways, including helping users determine how other users feel about a rating. The degree to which users can rely on voting information, however, is dependent upon a number of factors. For example, if a rating of “customer service is excellent” receives nine votes of strong disagreement and one vote of strong agreement, then users might be reasonably skeptical about customer service. But if the same rating has five votes of strong agreement and five votes of strong disagreement, then users may find the rating less reliable. The more that voting information favors either agreement or disagreement, the greater the “feedback consistency” associated with the rating. When there is a mix of agreement and disagreement with a rating, it may be said to have lower feedback consistency.

The total number of votes may also affect the reliability of voting information. Statistically speaking, the more votes associated with a rating, the more accurate the collection of votes can be said to be. For example, if a rating has only two votes, both indicating strong agreement, the rating has high feedback consistency, but the votes are statistically insufficient. “Statistical sufficiency” denotes the strength of the voting information according to the number of votes received, and it may be determined according to well known statistical methods.

Among other things, feedback consistency and statistical sufficiency may be used to determine which ratings to show to a user. For example, a rating with a statistically sufficient number of votes, but low feedback consistency may be shown less frequently than a rating with a statistically sufficient number of votes and high feedback consistency.

Other characteristics of the ratings may also be used to determine which ratings to show to a user. For example, such characteristics may include how recently a rating was created, whether the rating is positive or negative, and the credibility of the user that created the rating. A user's credibility may be determined by examining the feedback consistency across all of the user's ratings or, in other words, how frequently other users agree or disagree with the user. For example, if a user's ratings regularly have high feedback consistency indicating agreement, then that user would be more credible than a user with high feedback consistency indicating disagreement.

Similarly, the credibility of the users that voted on a rating may also be assessed and used as a characteristic when selecting ratings to show to a user. For example, a user's voting credibility may be determined based on how consistently the user's votes are aligned with the majority of votes across two or more ratings. If a user regularly votes the same as a majority of other users, that user may have a higher voting credibility than a user who regularly votes the same as a minority of other users. In this manner, ratings for which a high portion of the total votes are from users with high voting credibility may be shown more frequently than ratings for which a high portion of the total votes are from users with low voting credibility.

Ratings may also be selected randomly for display and/or according to any combination of the above characteristics. For example, if there is room to display five positive ratings and five negative ratings, the first three of each may be selected with the objective of having high feedback consistency and the other two may be selected at random.

Any combination of other rules may also be implemented to improve the helpfulness of the ratings that are presented to a user. For example, when a user creates a new rating, that rating may automatically receive one “strong agreement” vote. Additionally, users may be prevented from voting multiple times on the same rating, and a user's own ratings may be hidden or displayed according to the user's preferences (e.g., a user may have no interest in reading his or her own ratings, or the user may want to view his or her own ratings to see how well they are received by other users).

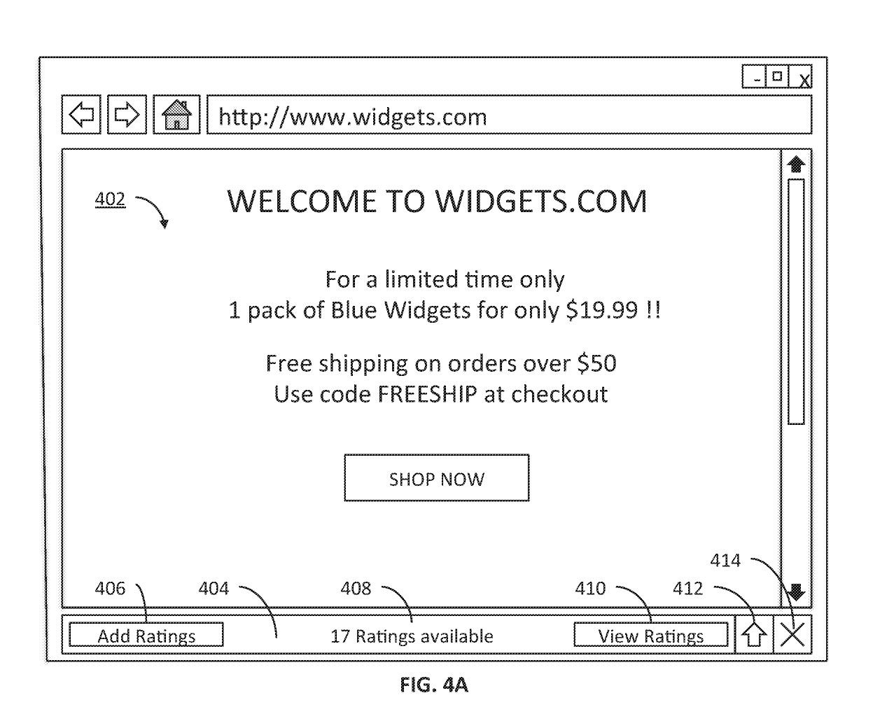

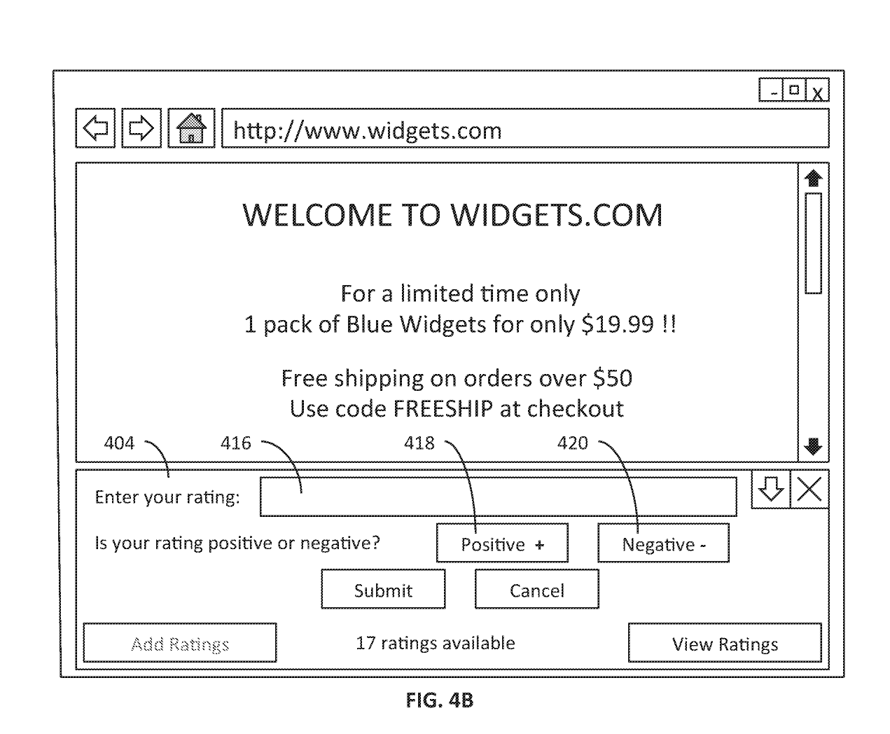

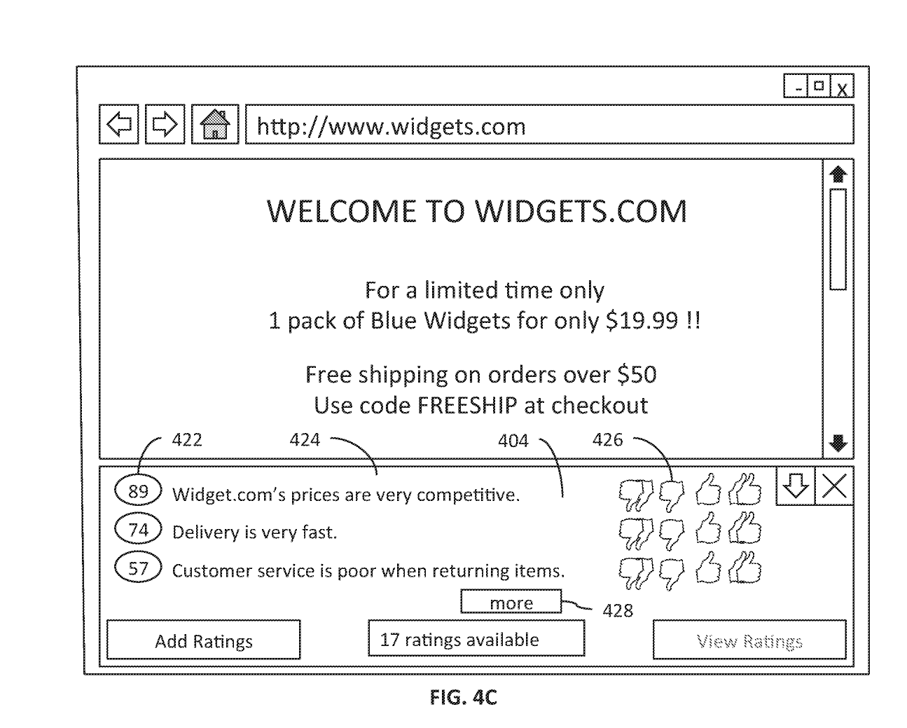

FIG. 4A illustrates a web browser window 402 and a rating module toolbar 404 created by Rating Module 106, in accordance with an embodiment of the invention. In this embodiment, a user navigates to a web page of interest (e.g., a web page with the URL “http://www.widgets.com”). Toolbar 404 may include a graphical user interface and may appear anywhere within the web browser window 402 (e.g., at the bottom, top, or side of the window, or floating within the window), or it may appear in its own window outside of the web browser window 402.

Toolbar 404 may include a rate button 406, a ratings indicator 408, a view button 410, a min/max button 412, and a close button 414. Selecting rate button 406 can permit a user to provide ratings related to the current web page as displayed by Web Browser 104. Ratings indicator 408 indicates the number of ratings that are available for the current web page. Selecting view button 410 permits a user to view the available ratings for the current web page. Selecting min/max button 412 either enlarges the toolbar 404 to its maximum size or reduces the toolbar 404 to its minimum size depending on its current state. Selecting close button 414 removes the toolbar 404 from the web browser window 402.

Toolbar 404 is in a minimized state in FIG. 4A. Selecting any of rate button 406, view button 410, and min/max button 412 can enlarge toolbar 404 to a maximum size.

FIG. 4B illustrates an embodiment of a web browser window with a rating module toolbar 404 in accordance with the present invention, in which the rating module toolbar 404 is enlarged to a maximized state after a user has selected a “rate” button 406. In this embodiment, a user may type a rating into textbox 416 and then may indicate whether the rating is positive or negative by selecting one of positive button 418 or negative button 420. The user may then submit the rating or cancel it by selecting a corresponding button.

As discussed above, a rating may be a declaration pertaining to an aspect of a web page or an item, entity, or service associated with the web page. In an embodiment, textbox 416 is limited to a predefined number of characters to encourage brevity in the ratings. There may also be a limit to the number of ratings a single user may enter for a particular web page. The limit may be fixed (e.g., 5) or it may vary based on one or a combination of factors, including the number of existing ratings, the user's credibility (e.g., users with more votes in favor of agreement may enter more new ratings), or other factors.

In an embodiment, toolbar 404 includes a second textbox (not shown) in which users may enter additional comments or a more complete review of the current web page. A review is associated with a rating and may be significantly longer than the rating. In an embodiment, reviews are only visible to users who specifically request more information about a particular rating, for example by clicking an expand button (not shown).

FIG. 4C illustrates an embodiment of a web browser window with a rating module toolbar 404 in accordance with the present invention, in which the rating module toolbar 404 is in a maximized state after a user has selected a “view” button 410. In this embodiment, a user may view existing ratings for the current web page. Each rating includes a score 422, a declaration 424, and voting buttons 426. The user may vote on a rating by selecting one of the voting buttons 426 that corresponds to their level of agreement with the declaration 424.

In an embodiment, the number of ratings that are shown to the user in toolbar 404 may be dependent on one or a combination of a variety of factors, including the toolbar's display limitations (e.g., size or resolution), the number of ratings that are available, user preferences, and/or user agreement level. A user may choose to see more ratings, for example, by selecting “more” button 428 or by using well-known scrolling methods. In the same or another embodiment, the ratings may be displayed in a new browser window, or for example in a new tab in a browser that supports multiple tabs.

In an embodiment, score 422 is a numerical score indicative of the user agreement level associated with the rating. Score 422 may be calculated in various ways, including by calculating an average score (i.e., a “representative score”) and/or by calculating the percentage of users that agree or disagree with a rating. In an embodiment, votes of agreement are tallied (e.g., by counting each “strong agreement” vote as 1 and each “mild agreement” vote as 0.5) and votes of disagreement are tallied (e.g., by counting each “strong disagreement” vote as 1 and each “mild disagreement” vote as 0.5). Each sum is divided by the total number of votes, thereby producing an agreement percentage and a disagreement percentage. The two percentages are then compared to see which is higher. If the agreement percentage is higher, it is presented as score 422. Otherwise, the disagreement percentage is presented as score 422. In an embodiment, an agreement percentage is displayed in the color green and a disagreement percentage is displayed in the color red. Other factors may also be considered in calculating agreement and or disagreement percentages. For example, more recent votes may be weighted more heavily than older votes.

In an embodiment, score 422 is a graphical score indicative of the user agreement level associated with the rating. A graphical score may use color-coding (e.g., where green shows more agreement than yellow or red), a bar graph (e.g., a longer bar shows more agreement than a shorter bar), or other graphical means. Score 422 may also include information indicative of whether the user agreement level for a rating is trending upward or downward. In an embodiment, a feedback server (e.g., Feedback Server 110) calculates the score 422.

As discussed above, declaration 424 may describe some aspect of the current web page or a corresponding item, entity, or service. For each declaration 424 displayed in toolbar 404, users may vote to indicate their level of agreement with the declaration 424. In an embodiment, users may choose one of four voting buttons 426. For example, two thumbs up may mean that the user strongly agrees with the declaration 424, while two thumbs down may mean that the user strongly disagrees with the declaration 424. One thumb up or one thumb down may mean that the user mildly agrees or mildly disagrees with the declaration, respectively.

The exemplary voting buttons 426 in FIG. 4C are for illustrative purposes only. Other mechanisms could be used to register user votes without departing from the scope of the invention, including sliders, radio buttons, drop down menus, and other well-known graphical user interface tools. For example, the voting buttons may simply have textual labels such as “strongly disagree,” “mildly disagree,” “mildly agree,” and “strongly agree.” Further, users may have more or less than four options. For example, users could vote on a 10-point scale using a slider tool. After a user selects a voting button 426, the vote is transmitted to a feedback server and the feedback for the currently displayed web page is updated accordingly.

In an embodiment, score 422 may include more specific information concerning the user agreement level. For example, a score may be presented in the manner illustrated in Table 1. In this example, the score for each rating includes the total number of votes as well as a percentage of the total that corresponds to each vote. Other score presentations are also possible, including graphs, charts, and other methods known in the art.

TABLE 1

| | Score | | | | |
|---|---|---|---|---|---|
| | Strong | Mild | | Strong | |
| | Disagree- | Disagree- | Mild | Agree- | Total |
| Rating | ment | ment | Agreement | ment | Votes |
| “Widget.com's | 5% | 18% | 32% | 45% | 340 |
| prices are very | | | | | |
| competitive.” | | | | | |
| “Delivery is | 4% | 16% | 60% | 20% | 125 |
| very fast.” | | | | | |

In addition to voting buttons 426, an embodiment can include one or more flag buttons (not shown) that permit users to flag ratings that are obscene, irrelevant, or otherwise inappropriate. The feedback server may automatically remove or hide ratings that are flagged a certain number of times (e.g., a predefined number, or by at least a certain percentage of the users voting on the rating).

In an embodiment, the invention can reduce the number of duplicate or similar ratings. For example, two users may wish to rate the same aspect of a web page, but neither user knows that the other user's rating already exists. The two ratings may be very similar, if not word-for-word identical. In addition to voting buttons 426, toolbar 404 may also include one or more similarity buttons, checkboxes, or other user interface controls (not shown) for each rating. For example, if a user notices that two or more ratings are similar, he or she may select a similarity button associated with (e.g., adjacent to) each of the similar ratings and then select another button (e.g., an “OK” button) to submit this information to the feedback server. The feedback server may then use this information to either remove redundant ratings or merge them into a single rating. In an embodiment, if a certain number of users (e.g., a predefined number) have indicated that two or more ratings are similar, the feedback server can merge the similar ratings to a single rating and combine all previous votes for the ratings accordingly. In an alternative embodiment, instead of merging similar ratings, the feedback server may reduce the frequency in which redundant ratings are displayed to users.

In the same or an alternative embodiment, the invention can reduce the number of duplicate or similar ratings by matching newly entered ratings with existing ratings. If a newly entered rating matches an existing rating, the newly entered rating may be excluded. Matching may be performed using known matching techniques in natural language processing that search for ratings with a certain degree of similarity (e.g., 80% of the key words match after eliminating common or generic words).

FIG. 5 is a block diagram of an exemplary embodiment of a Computing Device 500 in accordance with the present invention, which in certain operative embodiments can comprise, for example, a Client 102, a Feedback Server 110, or a Web Server 114. Computing Device 500 can comprise any of numerous components, such as for example, one or more Network Interfaces 510, one or more Memories 520, one or more Processors 530 including program Instructions and Logic 540, one or more Input/Output (I/O) Devices 550, and one or more User Interfaces 560 that may be coupled to the I/O Device(s) 550, etc.

Computing Device 500 may comprise any device known in the art that is capable of processing data and/or information, such as any general purpose and/or special purpose computer, including as a personal computer, workstation, server, minicomputer, mainframe, supercomputer, computer terminal, laptop, tablet computer (such as an iPad), wearable computer, mobile terminal, Bluetooth device, communicator, smart phone (such as an iPhone, Android device, or BlackBerry), a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general, any device on which a finite state machine resides that is capable of implementing at least a portion of the methods, structures, API, and/or interfaces described herein may comprise Computing Device 500. Such a Computing Device 500 can comprise components such as one or more Network Interfaces 510, one or more Processors 530, one or more Memories 520 containing Instructions and Logic 540, one or more Input/Output (I/O) Devices 550, and one or more User Interfaces 560 coupled to the I/O Devices 550, etc.

Memory 520 can be any type of apparatus known in the art that is capable of storing analog or digital information, such as instructions and/or data. Examples include a non-volatile memory, volatile memory, Random Access Memory, RAM, Read Only Memory, ROM, flash memory, magnetic media, hard disk, solid state drive, floppy disk, magnetic tape, optical media, optical disk, compact disk, CD, digital versatile disk, DVD, and/or RAID array, etc. The memory device can be coupled to a processor and/or can store instructions adapted to be executed by processor, such as according to an embodiment disclosed herein.

Input/Output (I/O) Device 550 may comprise any sensory-oriented input and/or output device known in the art, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, vibrator, tactile simulator, and/or tactile pad, optionally including a communications port for communication with other components in Computing Device 500.

Instructions and Logic 540 may comprise directions adapted to cause a machine, such as Computing Device 500, to perform one or more particular activities, operations, or functions. The directions, which can sometimes comprise an entity called a “kernel”, “operating system”, “program”, “application”, “utility”, “subroutine”, “script”, “macro”, “file”, “project”, “module”, “library”, “class”, “object”, or “Application Programming Interface,” etc., can be embodied as machine code, source code, object code, compiled code, assembled code, interpretable code, and/or executable code, etc., in hardware, firmware, and/or software. Instructions and Logic 540 may reside in Processor 530 and/or Memory 520.

Network Interface 510 may comprise any device, system, or subsystem capable of coupling an information device to a network. For example, Network Interface 510 can comprise a telephone, cellular phone, cellular modem, telephone data modem, fax modem, wireless transceiver, Ethernet circuit, cable modem, digital subscriber line interface, bridge, hub, router, or other similar device.

Processor 530 may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can comprise a general-purpose device, such as a microcontroller and/or a microprocessor, such the Pentium IV series of microprocessors manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

User Interface 560 may comprise any device and/or means for rendering information to a user and/or requesting information from the user. User Interface 560 may include, for example, at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The present invention can be realized in hardware, software, or a combination of hardware and software. The invention can be realized in a centralized fashion in one computer system, or in a distributed fashion where different elements are spread across several computer systems. Any kind of computer system or other apparatus adapted for carrying out the methods described herein is suitable. A typical combination of hardware and software can be a general-purpose computer system with a computer program that, when being loaded and executed, controls the computer system such that it carries out the methods described herein.

Although the present disclosure provides certain embodiments and applications, other embodiments apparent to those of ordinary skill in the art, including embodiments that do not provide all of the features and advantages set forth herein, are also within the scope of this disclosure.

The present invention, as already noted, can be embedded in a computer program product, such as a computer-readable storage medium or device which when loaded into a computer system is able to carry out the different methods described herein. “Computer program” in the present context means any expression, in any language, code or notation, of a set of instructions intended to cause a system having an information processing capability to perform a particular function either directly or indirectly after either or both of the following: a) conversion to another language, code or notation; or b) reproduction in a different material form.

The foregoing disclosure has been set forth merely to illustrate the invention and is not intended to be limiting. It will be appreciated that modifications, variations and additional embodiments are covered by the above teachings and within the purview of the appended claims without departing from the spirit and intended scope of the invention. Other logic may also be provided as part of the exemplary embodiments but are not included here so as not to obfuscate the present invention. Since modifications of the disclosed embodiments incorporating the spirit and substance of the invention may occur to persons skilled in the art, the invention should be construed to include everything within the scope of the appended claims and equivalents thereof.

The invention claimed is:

1. A computerized method for receiving and presenting web page ratings comprising:
receiving, at a web page rating module, an address for a web page that is currently displayed in a web browser, wherein the web page rating module is invoked by the web browser each time any web page is displayed in the web browser;
transmitting, from the web page rating module, via a network, the address to a web page feedback server;
receiving, at the web page rating module, from the web page feedback server, at least one of a plurality of ratings that are associated with the web page;
presenting the at least one of the plurality of ratings to a user while the user is viewing the web page in the web browser;
receiving, at the web page rating module, input from the user, wherein the input defines a new rating associated with the web page; and
transmitting, from the web page rating module, via the network, the new rating to the web page feedback server.

2. The method of claim 1, wherein each of the plurality of ratings comprises a declaration, the declaration describing an aspect of the web page or a corresponding item, entity, or service associated with the web page.

3. The method of claim 1, further comprising:
receiving, at the web page rating module, a score for at least one of the plurality of ratings, the score indicating a user agreement level associated with the at least one of the plurality of rating; and
presenting each score to the user while the user is viewing the web page in the web browser.

4. The method of claim 3, wherein the score is an average level of agreement or disagreement with the at least one of the plurality of ratings.

5. The method of claim 3, wherein the score is a percentage of users that agree or disagree with the at least one of the plurality of ratings.

6. The method of claim 1, further comprising receiving, at the web page rating module, a similarity indication from the user that two or more of the plurality of ratings are similar.

7. The method of claim 6, further comprising transmitting, from the web page rating module, the similarity indication, via the network, to the web page feedback server.

8. The method of claim 1, further comprising receiving, at the web page rating module, a vote from the user corresponding to a selected one of the plurality of ratings, the vote indicating a level of agreement or disagreement with the selected one of the plurality of ratings.

9. The method of claim 8, further comprising transmitting, from the web page rating module, the vote, via the network, to the web page feedback server.

10. The method of claim 1, further comprising receiving, at the web page rating module, additional input from the user, wherein the additional input comprises a selection of a positive or negative indicator associated with the new rating.

11. The method of claim 1, further comprising:
receiving, at the web page rating module, a second address for a second web page that is currently displayed in the web browser;
transmitting, from the web page rating module, via the network, the second address to the web page feedback server;
receiving, at the web page rating module, from the web page feedback server, at least one of a plurality of second ratings that are associated with the second web page; and
presenting the at least one of the plurality of second ratings to the user while the user is viewing the second web page in the web browser.

12. The method of claim 11, further comprising:
receiving, at the web page rating module, additional input from the user, wherein the additional input defines a second new rating associated with the second web page; and
transmitting, from the web page rating module, via the network, the new rating to the web page feedback server.

13. A computerized method for managing web page ratings comprising:
receiving, at a web page feedback server, from a web page rating module, via a network, an address for a web page, wherein the web page rating module is invoked by a web browser each time any web page is displayed in the web browser;
retrieving, at the web page feedback server, from a database, at least one of a plurality of ratings based on the address;
transmitting, via the network, the at least one of the plurality of ratings to the web page rating module;
receiving, at the web page feedback server, from the web page rating module, a new rating associated with the web page; and
storing the new rating in the database as being associated with the address.

14. The computerized method of claim 13, further comprising:
receiving, at the web page feedback server, via the network, a plurality of votes, wherein each vote is associated with one of the plurality of ratings.

15. The computerized method of claim 14, further comprising:
calculating, at the web page feedback server, a score for at least one of the plurality of ratings based on the plurality of votes.

16. The computerized method of claim 15, wherein the score is an average level of agreement or disagreement with the at least one of the plurality of ratings.

17. The computerized method of claim 15, wherein the score is a percentage of users that agree or disagree with the at least one of the plurality of ratings.

18. The computerized method of claim 13, wherein the retrieving of at least one of a plurality of ratings based on the address comprises:
querying the database with the address;
receiving a plurality of ratings in response to the querying; and
selecting at least one of the plurality of ratings based on at least one criterion.

19. The computerized method of claim 18, wherein the at least one criterion comprises a feedback consistency associated with each of the plurality of ratings.

20. The computerized method of claim 18, wherein the at least one criterion comprises a statistical sufficiency associated with each of the plurality of ratings.

21. The computerized method of claim 18, wherein the at least one criterion comprises a measure of how recently each of the plurality of ratings was created.

22. The computerized method of claim 18, wherein the at least one criterion comprises a credibility of one or more users who created each of the plurality of ratings.

23. The computerized method of claim 13, further comprising:
determining that two or more of the plurality of ratings are similar; and
merging the two or more similar ratings into a single rating.

24. A system for receiving, presenting, and managing web page ratings, comprising:
a network;
a web page rating module configured to:
receive, from a web browser, an address for a web page whenever any web page is displayed in the web browser;
transmit, via the network, the address to a web page feedback server;
receive, from the web page feedback server, at least one of a plurality of ratings that are associated with the web page;
present the at least one of the plurality of ratings to a user while the user is viewing the web page in the web browser;
receive input from the user, wherein the input defines a new rating associated with the web page; and
transmit, via the network, the new rating to the web page feedback server; and
a web page feedback server configured to:
receive, from the web page rating module, via the network, the address;
retrieve, from a database, the at least one of the plurality of ratings based on the address;
transmit, via the network, the at least one of the plurality of ratings to the web page rating module;
receive, from the web page rating module, the new rating; and
store the new rating in the database as being associated with the address.

25. The system of claim 24, wherein the webpage feedback server is further configured to receive, via the network, a plurality of votes, wherein each vote is associated with one of the plurality of ratings.

26. The system of claim 25, wherein the webpage feedback server is further configured to calculate a score for at least one of the plurality of ratings based on the plurality of votes.

27. The system of claim 24, wherein the webpage feedback server is further configured to retrieve, from the database, the at least one of the plurality of ratings based on the address by querying a database with the address, receiving a plurality of ratings in response to the query, and selecting at least one of the plurality of ratings based on at least one criterion.

28. The system of claim 27, wherein the at least one criterion comprises:
a feedback consistency associated with each of the plurality of ratings;
a statistical sufficiency associated with each of the plurality of ratings;
a measure of how recently each of the plurality of ratings was created; or
a credibility of one or more users who created each of the plurality of ratings.

29. The system of claim 24, wherein the webpage feedback server is further configured to determine that to or more of the plurality of ratings are similar and merge the two or more similar ratings into a single rating.

30. The system of claim 24, wherein each of the plurality of ratings comprises a declaration, the declaration describing an aspect of the web page or a corresponding item, entity, or service associated with the web page.
